(19) United States
(12) Patent Application Publication
(10) Pub. No.: US 2002/0029815 A1
(43) Pub. Date: Mar. 14, 2002

(54) Hose guide in the base of a robot

(76) Inventor: Peter Unglert, Augsburg (DE)

Correspondence Address: McGLEW AND TUTTLE, P.C., Counselors at Law, SCARBOROUGH STATION, SCARBOROUGH, NY, 10510-0827, US

(21) Appl. No.: 09/848,183

(22) Filed: May 3, 2001

(30) Foreign Application Priority Data
May 5, 2000 (DE) 200 08 054.7

(51) Int. Cl. F16L 3/00

(52) U.S. Cl. 138/106; 138/107

(57) ABSTRACT

In a hose guide in the base of a robot, having a hose with a lower and an upper hose arm interconnected by a curved hose head, the upper hose arm is horizontally displaced relative to the lower hose arm.

### FIELD OF THE INVENTION

The invention relates to a hose guide in the base or pedestal of a robot, having a hose with a lower hose arm and an upper hose arm, which are interconnected by a curved or bent hose head.

### BACKGROUND OF THE INVENTION

It is necessary to provide a reserve for the power supply of a robot or tools on the robot hand in view of the robot rotatability and more precisely the rotatability of its carousel about the A1 axis of the robot relative to the fixed base. For this purpose guidance thereof takes place in the robot base in the form of hoses, generally ribbed hoses, which are vertically oriented in such a way that from an introduction end a lower hose arm is guided along the bottom of the base, passes into a vertically bent hose head and from the latter passes into an upper hose arm along the underside of the carousel to an outlet opening therein for the extension of the cable along the robot. The lower and upper hose arms are superimposed in precisely vertical manner. This cable protective hose is guided on the outer wall of the robot base, namely along the jacket cover provided there. As a result there is scraping along the base jacket, so that wear occurs leading to inevitable expenditure for monitoring, repeated replacement and consequently stoppages, together with increased robot set-up times. In addition, the base height is solely determined by the necessary minimum bending radius of the cable protective hoses and the cable guided through the same and is consequently considerable and is in particular higher than the level required due to other constructional features of the robot in the vicinity of the robot base, such as the gear.

Therefore the problem of the invention is to provide an improved hose guide, whilst avoiding the aforementioned disadvantages.

### SUMMARY OF THE INVENTION

In the case of a hose guide of the aforementioned type, the invention solves the set problem in that the upper hose arm is displaced relative to the lower hose arm towards the vertical axis of the base.

Solely as a result of the horizontal displacement of the upper hose arm relative to the lower hose arm it is ensured that the hose head connecting them is inclined to the vertical and consequently a reduced overall height is obtained. If there is a vertical circumferential wall of the robot base, then as a result of the horizontal displacement the hose head is moved away from this vertical base wall and as a result the hose head on moving the hose, by rotating the carousel relative to the base, no longer scrapes along the base wall, so that the wear caused by this is eliminated.

Whereas fundamentally the inclined position of the hose could be from bottom to top and outwards, according to a preferred development the upper hose arm is displaced relative to the lower hose arm towards the vertical axis of the base, i.e. radially inwards. Thus, on attaining the aforementioned advantages there is a reduction of the necessary base height and a reduction of wear in the case of radial and maximum predetermined radial dimensions of the robot base and a wide mounting surface corresponding thereto is obtained, as would not be the case with the indicated vertical and differing arrangement of the hose or hose head in the base.

In a preferred development the upper hose arm is guided in a groove of the robot carousel, which has a smaller diameter than the receptacle of the lower hose arm on the robot base. This ensures a reliable guidance of the hose, particularly the upper hose arm. In a further development the carousel has a radially directed ring flange surrounding and lowered with respect to the upper hose arm (then in the upper region), the ring flange being in particular lowered with respect to the groove receiving the upper hose arm. Thus, on the top of the carousel and more precisely on the top of the lowered ring flange thereof additional free space is created for receiving constructional elements, or for a hose continuation on the top of the carousel. As a result it is also possible to optically further lower the robot base height.

According to a further development there is a pitch conical base jacket. With an optimum standing surface, this gives the base a more attractive appearance and with a view to reducing the upper area of the base and consequently the carousel area a material saving is obtained, without the base foot resting on the floor having to have a reduced surface with respect to stability.

### BRIEF DESCRIPTION OF THE DRAWINGS

Further advantages and features of the invention can be gathered from the claims, together with the following description explaining in detail embodiments of the invention and with reference to the attached drawings, wherein show:

FIG. 1 A side view of a known robot.

FIG. 2 An embodiment of the base of a known robot in cross-section.

FIG. 3 A preferred development of the invention with lowered radial flange on the carousel of a robot and a frustum-shaped base.

FIG. 4 A representation of the inventive guide of a hose for the power supply cables of the robot drives in a robot base with a displacement from the upper to the lower hose arm.

FIG. 5 A representation of the inventive guide of a hose for power supply cables.

### DETAILED DESCRIPTION OF THE DRAWINGS

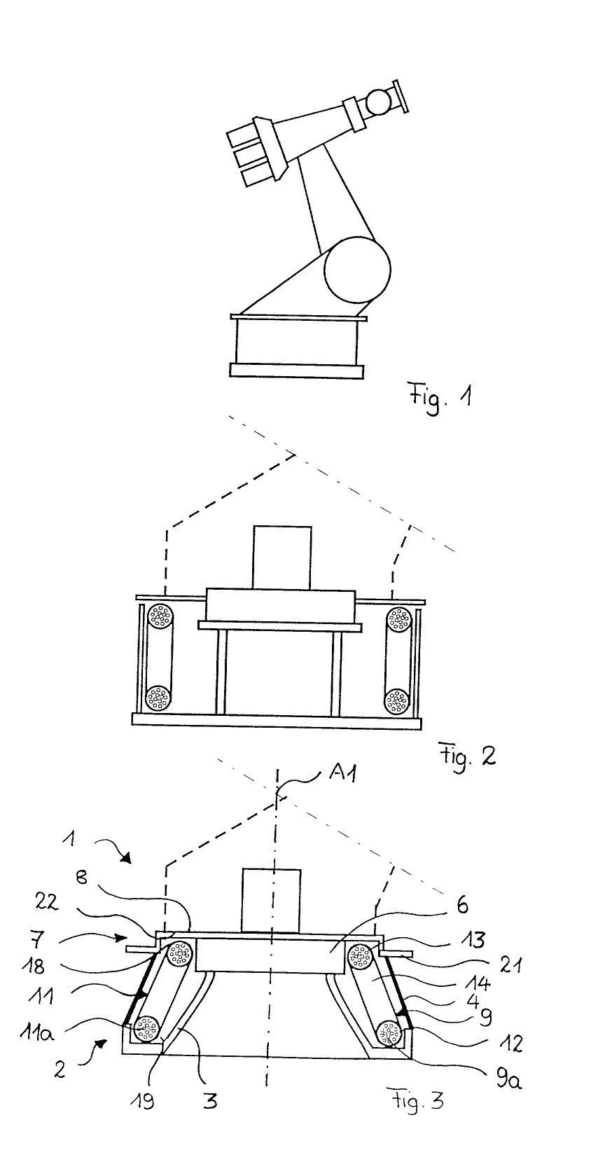

FIG. 1 shows a known robot in side view having a cylindrical base. FIG. 2 shows in section the base of the robot of FIG. 1. It is clear that to the left and right the cable hoses are U-shaped, one U-web being vertically oriented and the U-legs of the hoses are precisely vertically superimposed.

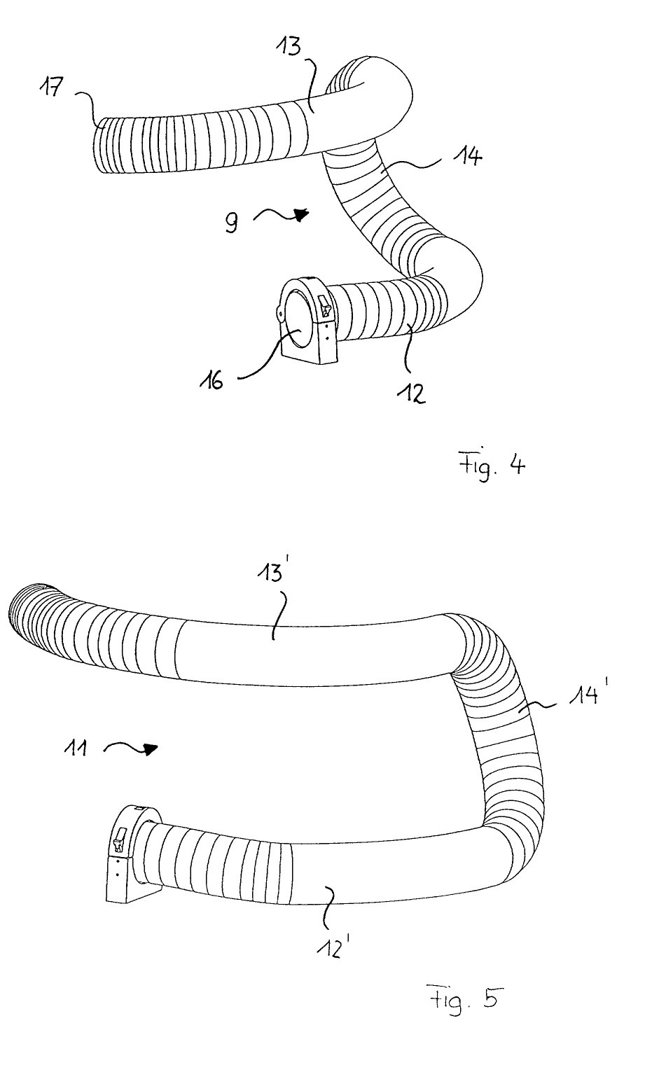

FIG. 3 shows, in partly broken away form, the lower area of a robot 1 constructed according to the invention with a fixed base 2, which comprises a base core 3 and optionally a base jacket 4. On and carried by the base core 3 is located the robot carousel 7 with a carousel plate 8 and which can be rotated by means of a gear 6. On said plate is located the further structure of the robot, namely a motor for driving the carousel plate 8, an articulation with which the rocker arm is movable about the A2 axis thereof and optionally a torque compensation for the rocker arm. These parts are not shown in detail in FIG. 3, because they are not essential to the object of the invention. In the robot shown the base 2 contains a hose 9 and optionally a hose 11. In the hose 9, which is usually constructed as a ribbed hose, are located cables 9a for the power supply of the different robot drives, whereas in hose 9 there are optionally cables 11a for the power supply of a robot tool. As explained relative to hose 9, the hoses 9, 11 comprise a lower hose arm 12 and an upper hose arm 13, which are interconnected by means of a hose head 14 (FIG. 4). Hose arm 13 is positioned higher than hose arm 12. The free end 16 of lower hose arm 12 is arranged in fixed manner and here the power supply cables are introduced from the outside. The free end 17 of the upper hose arm 13 is firmly connected with the carousel 7 movable relative to the base 2 and consequently during movements of the robot or more precisely the carousel there is a position change thereof relative to the inlet end 16 of the hose 9. The hose 9 forms a length reserve for compensating the necessary hose length during a relative movement of the carousel 7 with respect to the base 2. Thus, the hose 11 comprises a lower hose arm 12′, the hose head 14 and the upper hose arm 13′ (FIG. 5).

FIGS. 3 to 5, which show the invention, make it clear that the upper hose arm 13, 13′ is not positioned precisely vertically over the lower hose arm 12, 12′, as is the case in the prior art and instead the hose arm 13 is displaced relative to the hose arm 12 towards the vertical A1 axis of the robot, i.e. radially inwards and consequently has a smaller radius of curvature than the hose arm 12, 12′. Thus, as can in particular be gathered from FIG. 3 in conjunction with FIG. 4, it is ensured that the hose head 14, 14′ does not scrape along the robot base wall 4, as is the case in the prior art where it regularly leads to wear requiring a constant monitoring of the hose state and a frequent replacement of the hose, with the unavoidable consequences of robot stoppages, additional setting-up times, etc.

The upper hose arm 13, 13′ is guided in a carousel groove 18, which is also displaced towards the A1 axis and therefore radially inwards with respect to a groove-like receptacle 19 in the lower area of the base core 3 for the lower hose arm 12.

As is shown in FIG. 3 on carousel 7 can be provided a radially directed ring plate 21, which is lowered with respect to the horizontal inner wall of the groove 18. The height of the horizontal inner wall 22 of the groove 18 is determined by the necessary minimum bending radii of the hose, which give rise to a considerable overall height and therefore a positioning of the wall 21 above the floor, whilst the height of the wall 22 is predetermined by the hose and its minimum bending radii.

FIGS. 4 and 5 show the hoses 9, 11 if the carousel is pivoted clockwise with respect to its central position, so that the spacing of the hose head 14 of the hose 9 with respect to the entry point of the lower hose arm has reduced, whereas the hose head 14′ of hose 11 has a greater spacing compared with the normal position with respect to the entry point of the lower hose arm 12′.

The ring plate 21 lowered compared with wall 22 is located outside the groove 18, so that space is available on its top surface for receiving further elements, such as e.g. the continuation of the hose outside the base 2. In addition, as a result of the inclined hose guide arrangement according to the invention the effective overall height of the base is reduced, because the hose head is inclined and therefore takes up a smaller overall height for the same bending radius. In addition, the optical overall height of the base in the case of FIG. 1 is reduced by the lowered ring plate 21, which gives the robot base a more attractive appearance compared with conventional, high bases. This is further aided in that if, as shown in FIG. 3, the base wall of the inclined hose guide follows the side wall 4′ of the base 2 in conical or pitch conical manner. Alternatively the base circumferential wall 4 can also be vertically oriented and terminate with the outer edge of the ring plate 21.

1. Hose guide in the base (2) of a robot (1), having a hose (9) with a lower hose arm (13) and an upper hose arm (12), which are interconnected by a curved hose head, characterized in that the upper hose arm (12) is horizontally displaced relative to the lower hose arm (13).

2. Hose guide according to claim 1, characterized in that the upper hose arm (13) is displaced relative to the lower hose arm (12) towards the vertical axis (A1 axis) of the base (2).

3. Hose guide according to claim 1, characterized in that the upper hose arm (13) is guided in a groove (18) of the carousel (7) of robot (1), which has a smaller diameter than the receptacle (19) of the lower hose arm (12) on the base (2) of the robot (1).

4. Hose guide according to claim 1, characterized in that the carousel (7) has a radially directed ring flange (21) surrounding and lowered with respect to the upper hose arm (13) (then in the upper area).

5. Hose guide according to claim 1, characterized by a pitch conical jacket (4a) of the base (2).
